(19) United States
(12) Patent Application Publication
(10) Pub. No.: US 2026/0172286 A1
(43) Pub. Date: Jun. 18, 2026

(54) Platform-Agnostic 5G Distributed Unit Physical Layer

(71) Applicant: Parallel Wireless, Inc., Nashua, NH (US)

(72) Inventors: Ayoub Girach, Cheltenham (GB); Joe Holland, Bristol (GB); Nicolas Scheidecker, Bath (GB)

(21) Appl. No.: 19/418,917

(22) Filed: Dec. 12, 2025

Related U.S. Application Data
(60) Provisional application No. 63/733,375, filed on Dec. 12, 2024.

(51) Int. Cl. H04L 25/02; H04L 69/323

(52) U.S. Cl. CPC H04L 25/0202; H04L 25/0262; H04L 69/323

(57) ABSTRACT

Disclosed is a platform-agnostic 5G Distributed Unit (DU) Physical Layer (PHY) application deployable on general-purpose processors (GPPs) across multiple CPU architectures. The disclosed system decouples DU software from specific hardware platforms by utilizing SIMD abstraction and substitution libraries that enable portable vectorized signal processing. The PHY application may be deployed on both x86-based and Arm-based processors from a single source codebase. In-memory signal processing techniques minimize latency by managing data through pointers and performing operations in registers. The architecture supports containerized deployment and enables operators to select hardware components tailored to their requirements while maintaining functional equivalence across platforms. The disclosed approach may provide energy efficiency benefits through flexible processor selection.

### CROSS-REFERENCE TO RELATED APPLICATIONS

This application claims the benefit under 35 U.S.C. § 119(e) or PCT Article 8(1), whichever is deemed presently applicable, of U.S. Provisional Application No. 63/733,375, the entire contents of which are hereby incorporated by reference. In addition, U.S. Patent Application Publication No. US20230269633A1 is incorporated by reference in its entirety. In addition, each of the following references are incorporated by reference in their entirety for all purposes: UK 5G supply chain diversification strategy (Dec. 7, 2020), ISBN 978-1-5286-2283-7; 5GUK test bed https://www.bristol.ac.uk/research/groups/csn/projects/past/5g/; SCF 222.10.04, Small Cell Forum 5G FAPI: PHY API Specification; 3GPP TS 38.300v15.13.0 , NR and NG-RAN Overall Description; 3GPP TS 38.401v15.9.0 , NG-RAN; Architecture description; 3GPP TS 38.470v15.8.0 , NG-RAN; F1 general aspects and principles; 3GPP TS 38.801v14.0.0 , Study on NR; Radio access architecture and interfaces; 3GPP TS 38.104v15.16.0 , NR; Base Station radio transmission and reception; 3GPP TS 38.211v15.10.0 , NR; Physical channels and modulation; 3GPP TS 38.212v15.13.0 , NR; Multiplexing and channel coding; 3GPP TS 28.541 v15.8.0, 5G Network Resource Model; O-RAN. WG4.CUS.0 v07.00, O-RAN Fronthaul Working Group; Control, User and Synchronization Plane Specification.

### FIELD OF THE INVENTION

The present disclosure relates to the field of wireless communications, specifically to the deployment of a platform-agnostic 5G Distributed Unit (DU) Physical Layer (PHY) on general-purpose processors (GPPs).

### BACKGROUND

The wireless communications industry has undergone significant transformation due to advancements in CPU and datacenter technologies. Traditional Radio Access Network (RAN) solutions rely on purpose-built chips known as Application Specific Integrated Circuits (ASICs) for computationally intensive signal processing tasks. However, the latest general-purpose processors (GPPs) have become sufficiently performant to support these workloads through Single Instruction Multiple Data (SIMD) capabilities. Despite this, the lack of portability of SIMD code and licensing restrictions pose significant barriers to enabling comprehensive competition and supply chain diversity for GPP-based Open RAN DU products.

### SUMMARY

The objective of the present disclosure is to solve the challenge of enabling better supply chain diversification by developing a 5G DU PHY application deployable on any general-purpose CPU. The disclosure validates this approach by deploying the 5G DU PHY on differentiated platforms, including at least one x86-based and one Arm-based GPP, in a representative environment.

### BRIEF DESCRIPTION OF THE DRAWINGS

FIG. 1 shows 3GPP Functional Splits, in accordance with some embodiments.

FIG. 2 shows a VBBU in the 5G network, in accordance with some embodiments.

FIG. 3 shows a VBBU in an all-G network, in accordance with some embodiments.

FIG. 4 shows 5G protocol stacks—control-plane, in accordance with some embodiments.

FIG. 5 shows 5G protocol stacks—user-plane, in accordance with some embodiments.

FIG. 6 shows SCF 5G FAPI Ports, in accordance with some embodiments.

FIG. 7 shows O-DU-PHY application and its main external dependencies, in accordance with some embodiments.

FIG. 8 shows a flowchart, in accordance with some embodiments.

### DETAILED DESCRIPTION

### Introduction

Open Radio Access Network (Open RAN) is an approach to telecommunications network architecture that disaggregates traditional base station components into interoperable, standards-based elements from multiple vendors. In a conventional RAN deployment, the baseband unit and radio unit are typically provided as an integrated system from a single vendor. Open RAN architectures separate these functions into distinct components including the Centralized Unit (CU), Distributed Unit (DU), and Radio Unit (RU), which communicate over standardized interfaces. The DU performs physical layer (PHY) processing and is responsible for real-time baseband functions, while the RU handles radio frequency transmission and reception at the cell site. In centralized RAN deployments, the virtual Baseband Unit (vBBU), comprising both the CU and DU, operates from a remote data center with only the RU located at the cell site.

Traditionally, DU software stacks have been tightly coupled to specific computing platforms, predominantly x86-based processors from Intel. This coupling has limited operator flexibility in hardware selection and constrained supply chain options. General-purpose processors (GPPs) based on Arm architecture have emerged as an alternative computing platform for telecommunications infrastructure. Arm-based processors, such as those in the NXP Layerscape family, offer potential advantages including reduced power consumption and access to a broader ecosystem of semiconductor manufacturers. The ability to decouple DU software from the underlying processor architecture—enabling the same software stack to operate on both x86 and Arm-based platforms—represents an evolution toward hardware-agnostic RAN solutions.

5G standalone (SA) networks operate independently of legacy 4G infrastructure and require a 5G core network. Such networks may be deployed as private networks for research, enterprise, or industrial applications. Components of a 5G Open RAN deployment include the 5G core (which may itself be processor-agnostic), the CU, the DU with its physical layer processing, and the RU operating in designated frequency bands such as the n77 band. The O-RAN Alliance has defined specifications for open interfaces between these components, facilitating multi-vendor interoperability and enabling operators to select hardware and software components that best suit their deployment requirements.

Accordingly, over the past 15 years the wireless communications industry has begun a profound transformation, triggered by technological improvements in CPU and datacentre technologies and the commoditization of compute platforms. Intel was first to realise that the wireless communications industry could benefit from these opportunities and started in 2010 what was later to become the FlexRAN program. In 2016 Facebook, Intel and Nokia founded the Telecom Infra Project (TIP) to federate the efforts of technology vendors, RAN equipment manufacturers, integrators and operators, towards a goal of reducing the cost of communications infrastructure and make these accessible to most. In 2018, 5 operators (AT&T, China Mobile, Deutsche Telekom, NTT DOCOMO and Orange) founded the O-RAN Alliance industry group to define standard interfaces and organize the ecosystem to be more open and interoperable.

The benefits of these approaches are clear: Open interfaces enable more players to enter the RAN infrastructure market, increase competition and as a result accelerate innovation and change. Generic COTS platforms enable economies of scale, a reduction in Capex and facilitate reuse of application software through platform generations. Standard tools, virtualization and cloud-based technologies enable scalability, agility and reduced Opex.

The first part of the network to undergo this change at scale was the core network, but the industry focus has now turned towards the more technically challenging RAN. Within the RAN the DU, and particularly the physical layer (also known as the PHY, layer 1 or L1), presents a difficult challenge because of the computational intensity of the signal processing algorithms within the base-station. Meeting these computational demands had traditionally required the design of purpose-built chips known as ASICs, which demand very large investments, limit access to the market to large players and are typically not interchangeable and not backward compatible through generations.

Relatedly, SIMD (Single Instruction, Multiple Data) is a computing paradigm in which a single instruction is applied to multiple data values simultaneously, enabling processors to perform operations such as adding multiple numbers with a single instruction rather than iterating through values individually. SIMD is commonly employed in data-parallel workloads including image, audio, and video processing; numerical computing and high-performance computing applications; machine learning inference; cryptography and checksum calculations; database analytics and search operations; compression and text processing; and graphics and game engine computations. The benefits of SIMD include increased throughput, improved energy efficiency through reduced instruction overhead, and lower latency in vectorized loops.

Modern processor architectures implement SIMD capabilities through various instruction set extensions. x86 instruction set processors from Intel and AMD support SSE, AVX, and AVX-512 instruction sets, with AVX-512 providing 512-bit vectors, mask registers, and gather/scatter operations. Arm processors implement NEON (fixed 128-bit vectors) and SVE/SVE2 (scalable vectors ranging from 128 to 2048 bits with runtime-determined width). RISC-V processors implement the RVV (RISC-V Vector) extension, which similarly provides vector-length-agnostic operation where width is determined at runtime. WebAssembly SIMD provides a standardized 128-bit SIMD capability for browser and edge runtime environments. Several open-source libraries exist to facilitate portable SIMD programming across these diverse architectures. Notably, different bit lengths exist for SIMD instructions, but various libraries exist for genericising SIMD instructions across instruction sets. Google Highway is a C++ library providing length-agnostic vector programming with support for static or runtime dispatch across multiple instruction set targets. SIMD Everywhere (SIMDe) is a header-only C portability layer that cross-maps intrinsics between instruction set architectures. NSIMD supports both fixed-width and vector-length-agnostic paradigms across CPUs and GPUs. The rten-simd Rust crate provides runtime dispatch with explicit design consideration for scalable vector architectures. Where an abstraction library is mentioned herein, each of these libraries could be used, or an equivalent thereto.

The latest general-purpose processors CPUs (GPPs) have become sufficiently performant to support telecom workloads due to their ability to operate on arrays of data (vectors) rather than element per element, e.g., SIMD. But as explained above, SIMD programming is a specialist task and the language used to do so is CPU-specific. This means that telecom SIMD code written for a chip such as an Intel general purpose processor (GPP) will not run on an Arm based GPP, and vice versa.

Addressing this problem, this disclosure describes a 5G DU PHY application deployable on any general-purpose CPU, ideally from a single source of software.

With its first hardware-agnostic Distributed Unit in 5G Open RAN, the present disclosure allows for decoupling DU software from specific platforms for enhanced operator flexibility. Embracing a variety of processor architectures opens doors to an extensive supply chain, allowing operators to select components tailored to their unique needs. Additionally, this provides an opportunity for substantial energy savings, a significant leap toward a sustainable and green network infrastructure.

The Parallel Wireless 5G SA solution is purposefully architected to run on any general-purpose computing platform, including both ARM and Intel x86. Therefore, any updates or future enhancements are automatically compatible with both platforms. This assures the broadest range of computing support in the industry, providing optimal compatibility and flexibility for a wide variety of deployments.

Some of the abbreviations used in this disclosure are: Application Specific Integrated Circuit (ASIC); Baseband Device (in DPDK) (BBDev); Core Network (CN); Central Processing Unit (CPU); Central Unit (CU); Department for Digital, Culture, Media and Sport (DCMS); Data Plane Development Kit (DPDK); Distributed Unit (DU); Function Application Platform Interface (FAPI); Forward Error Correction (FEC); Fronthaul (DU-RU interface) (FH); Future of RAN Competition (FRANC); Grand Master (PTP reference clock) (GM); 5G basestation (gNB); General Purpose Processor (GPP); Network Interface Card (NIC); New Radio (5G) (NR); Open RAN (O-RAN); Peripheral Component Interconnect express (PCIe); Precision Timing Protocol (IEEE-1588) (PTP); Radio Access Network (RAN); Remote Radio Head (RRH); Radio Unit (RU); Small Cell Forum (SCF); Software Development Kit (SDK); Same Instruction Multiple Data (vectorisation) (SIMD); System on a Chip (SoC); Technology Readiness Level (TRL); Virtualised Baseband Unit (VBBU).

### Radio Unit Functional Splits

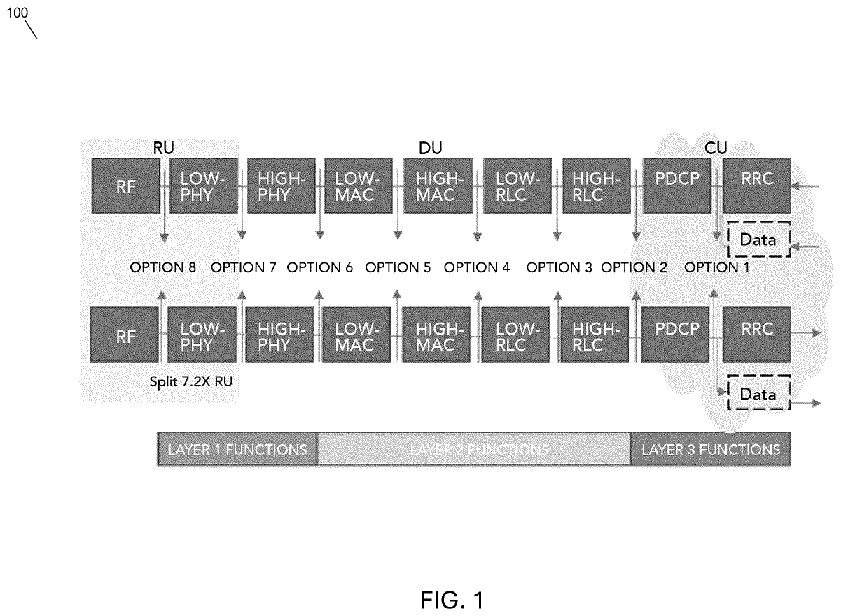

FIG. 1 shows a schematic diagram of radio functional splits showing split 7.2X RU as well as other splits, in accordance with various embodiments of the present disclosure. The use of these functional splits is encouraged by ORAN.

5G New Radio (NR) was designed to allow for disaggregating the baseband unit (BBU) by breaking off functions beyond the Radio Unit (RU) into Distributed Units (DUs) and Centralized Units (CUs), which is called a functional split architecture. This concept has been extended to 4G as well.

RU: This is the radio hardware unit that coverts radio signals sent to and from the antenna into a digital signal for transmission over packet networks. It handles the digital front end (DFE) and the lower PHY layer, as well as the digital beamforming functionality. 5G RU designs are supposed to be inherently intelligent, but the key considerations of RU design are size, weight, and power consumption. Deployed on site.

DU: The distributed unit software that is deployed on site on a COTS server. DU software is normally deployed close to the RU on site and it runs the RLC, MAC, and parts of the PHY layer. This logical node includes a subset of the eNodeB (eNB)/gNodeB (gNB) functions, depending on the functional split option, and its operation is controlled by the CU.

CU: The centralized unit software that runs the Radio Resource Control (RRC) and Packet Data Convergence Protocol (PDCP) layers. The gNB consists of a CU and one DU connected to the CU via Fs-C and Fs-U interfaces for CP and UP respectively. A CU with multiple DUs will support multiple gNBs. The split architecture lets a 5G network utilize different distributions of protocol stacks between CU and DUs depending on midhaul availability and network design. It is a logical node that includes the gNB functions like transfer of user data, mobility control, RAN sharing (MORAN), positioning, session management etc., except for functions that are allocated exclusively to the DU. The CU controls the operation of several DUs over the midhaul interface. CU software can be co-located with DU software on the same server on site.

When the RAN functional split architecture is fully virtualized, RU, CU and DU functions runs as virtual software functions on standard commercial off-the-shelf (COTS) hardware and (for CU and DU) can be deployed in any RAN tiered datacenter, limited by bandwidth and latency constraints. Each of these functions benefit from running on GPPs and therefore benefit from the ability to select an appropriate GPP using the technology described herein.

Option 7.2 is the functional split chosen by the O-RAN Alliance for 4G and 5G. It is a low-level split for ultra-reliable low-latency communication (URLLC) and near-edge deployment. RU and DU are connected by the eCPRI interface with a latency of ˜100 microseconds. In O-RAN terminology, RU is denoted as O-RU and DU is denoted as O-DU. Further information is available in US20200128414A1, hereby incorporated by reference in its entirety.

### 5G Network Overview

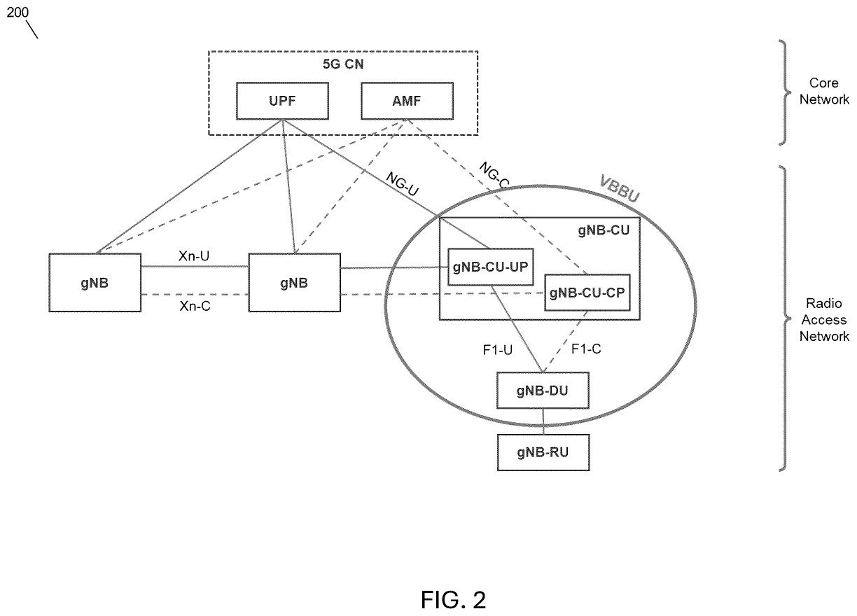

FIG. 2 identifies the key elements in a 5G standalone network, highlighting the VBBU where the software development for the present project is focused, although in various embodiments, other areas of the network can be adapted to use the present disclosure.

Testing has been performed to validate the present solution, including with Parallel Wireless CU and DU gNBs in a datacenter and O-RAN compliant O-RU radios in band n77.

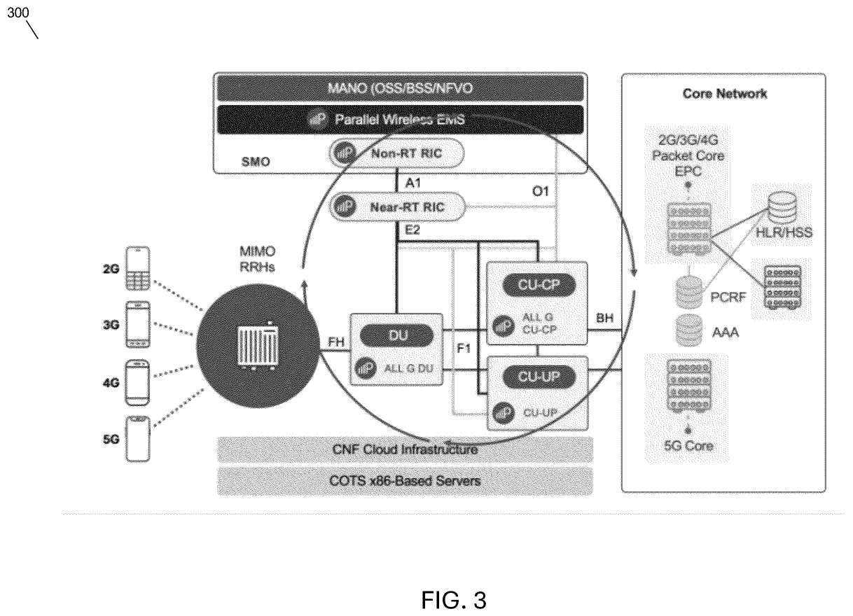

FIG. 3 Parallel Wireless All-G Network Architecture

FIG. 3 shows the Parallel Wireless All-G network architecture, showing that the present disclosure is suitable for use in a mixed or all-G network.

### Parallel Wireless gNB CU and DU

The Parallel Wireless gNB solution used in the present solution consists of a single VBBU server running a CU and DU as distinct entities. The CU-DU partitioning follows the 3GPP Split Option 2 definition, with the F1 interface between them. The CU is further split between the user-plane, connected back to the UPF in the 5G core, and the control-plane, connecting to the AMF. The DU-RU partitioning follows the 3GPP Split Option 7-2 definition, elaborated by O-RAN, with the upper-PHY running in the DU and the lower-PHY located in the RU.

In the present project the CU connects 1:1 with the DU, together forming a vNode and serving a single 5G cell (sector), for simplicity.

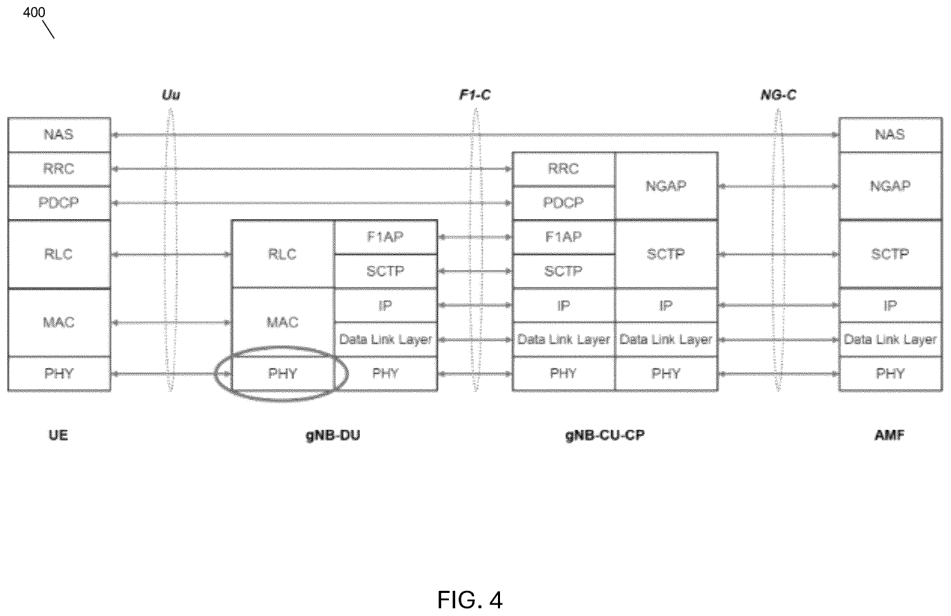

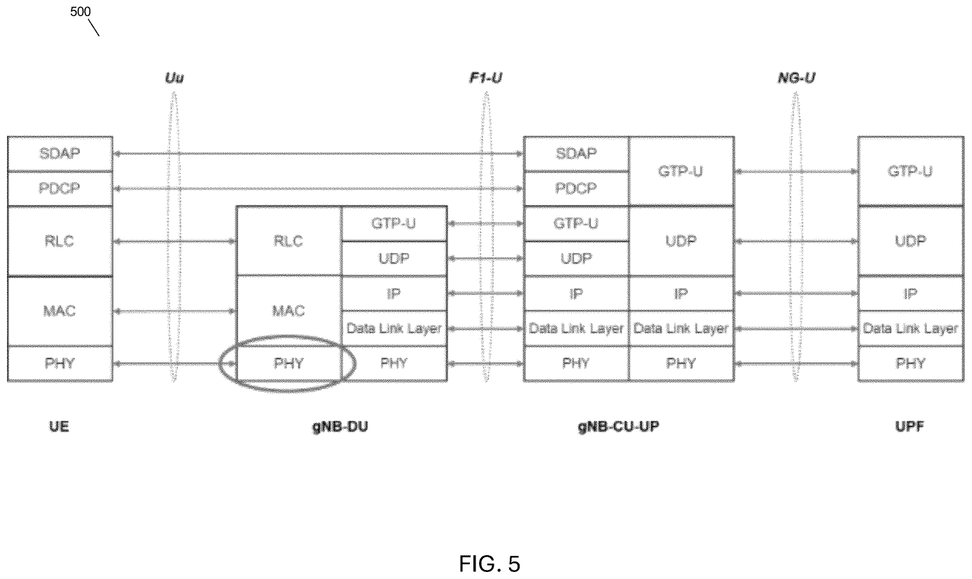

Pushing down into more detail, FIG. 4 and FIG. 5 capture the protocol stacks for the 5G control-plane and user-plane respectively; refer to [4] and [6] for more details. In the present project we focused particularly on the NR PHY in the gNB-DU as highlighted—this is where the platform-agnostic functionality is highly beneficial.

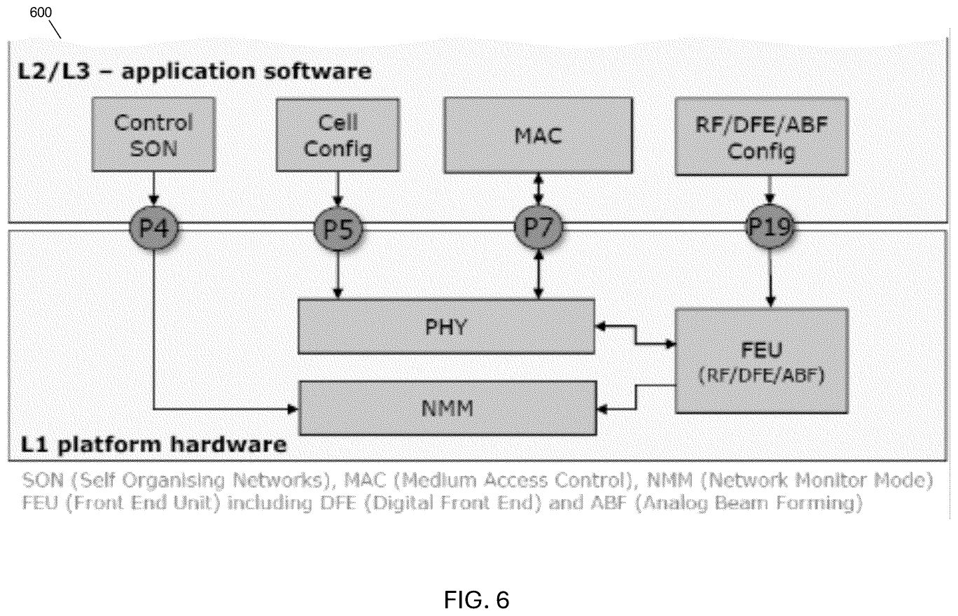

FIG. 6 shows an appropriate L2-L1 API, in accordance with some embodiments, based on the Small Cell Forum (SCF) 5G FAPI ports. With the move to a generic, portable PHY, it is also appropriate to move to a generic L2-L1 API to enable maximum flexibility. We decided to adopt the 5G FAPI [3] from the Small Cell Forum, a widely used open-source definition. The SCF also provide ongoing development of the 5G FAPI to align with advances in the 3GPP releases. Note that other L2-L1 APIs could be used.

Note that the full SCF 5G FAPI^{[1]} defines a set of message ports which include functionality such as SON and RRH configuration, but for the purposes of the present project we only focused at the PHY ports: P5 (PHY control-plane) and P7 (PHY user-plane).

### DU PHY and Stack Separation

Although this project's main focus was the NR PHY part of the gNB-DU, and though on order to control scope all other elements of the gNB DU were kept unchanged in the project, based on Parallel Wireless'standard 5G product (for this reason the L2/L3 elements were pinned to a fixed Intel Xeon based platform, and the PHY+radio interface deployed on a range of target platforms, following a topology known as in-line), other portions of the stack could also be made hardware agnostic in the same way as discussed herein. As discussed elsewhere herein, the use of, e.g., APIs and layering as described herein allows multiple different processor platforms to be integrated in a single signal chain, in some embodiments.

### Physical Layer

Traditional RAN solutions, in particular the “core” signal processing elements of the PHY, are tightly coupled with the platform they execute on for reasons of compute efficiency, which in turns translates into cost and power efficiency. This coupling can take place in a number of ways including:

Tailoring the software architecture of the PHY to the underlying CPU instruction set (e.g. through using CPU-specific SIMD intrinsics) and CPU core characteristics (e.g. through tailored mapping of tasks to cores and utilisation of proprietary thread scheduling frameworks) of the target platform;

Utilising hardware acceleration and/or offload for compute intensive and/or latency critical functions; utilising platform specific tools—e.g. specialised compilers, libraries.

### Guiding Principles

The development of the PHY was guided by the following principles:

Functional equivalence: The hardware abstracted software must be deployable with the same feature set on the range of enabled platforms. Exceptions are only acceptable on hardware capacity grounds.

Algorithmic near-equivalence: Hardware abstraction techniques must enable an algorithm to be implemented with equivalent or near equivalent (wireless) performance on the range of enabled platforms.

Code reuse: The hardware abstraction framework must enable the PHY application to be written and maintained as one code base, and to limit the amount of platform specific code to a well segregated minimum.

Compute performance: The hardware abstraction should enable the compute performance features of the target platforms—specifically SIMD vectorisation—to be exploited optimally or near optimally.

Flexibility: The PHY application solution is expected to be deployable on GPPs ranging from low cost embedded SoCs to high end COTS server cores to cloud platforms. As such the software architecture shall offer some flexibility e.g. be deployable onto “pools” of cores of varying size.

IP portability: The PHY must not use any 3^{rd} party tool or library restricting its utilisation onto processors of a specific type or vendor.

Future proofing: Where possible the abstracted code shall be constructed using techniques facilitating enablement on additional platforms or CPU architectures.

### Physical Layer Architecture

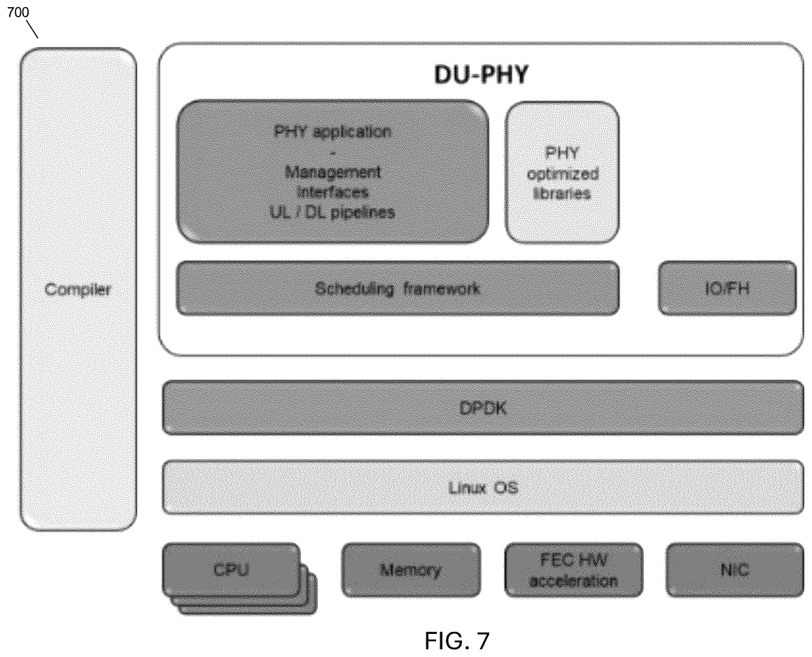

In the present project the functionality of the PHY has been decomposed into a number of sub-processes, or threads, mappable to a variable number of cores. Within each of the processing threads the PHY needs to be as decoupled as possible from the implementation specificities to the platform, for example its instruction set, memory interface, network interface, or accelerated functions capabilities. The main hardware abstraction interfaces are shown in FIG. 7.

In a particular embodiment developed by the inventors, certain elements were selected as the basis for its architecture. Other choices for each of the following three functional blocks are also contemplated for alternate embodiments and as equivalents.

### Linux Scheduler

Linux is the most widely deployed operating system and is increasingly well suited for real time applications. During the PHY development we analysed context switching latency times in detail and concluded that the flexibility benefits of a pre-emptive task execution framework outweigh the small performance cost of task switching. Together with suitably partitioned workloads and the ability to parallelise some tasks across pools of cores, this allows great flexibility in the choice of the target CPU. Other schedulers and base OSes could be used, such as a real time OS (RTOS). Note that a containerized architecture is used, as described further below.

### DPDK

Data Plane Development Kit (DPDK) is a Linux Foundation project that consists of libraries to accelerate packet processing workloads running on a wide variety of CPU architectures. DPDK is available on Intel and AMD x86, Arm, as well as RISC-V platforms. It provides an efficient abstraction framework to interface hardware functions including the platform's memory interface, the network interface hardware and the FEC lookaside accelerators, with a common API. The library also enables a generic interface to other blocks such as GPUs and machine learning engines. DPDK itself provides features for hardware abstraction (EAL (environment abstraction layer) for interfacing with underlying hardware, efficient memory management, poll mode drivers for various network interfaces, ring buffers, crypto and security, eventdev and timers, APIs for packet processing), allowing it to be effectively integrated into a platform-agnostic PHY solution. DPDK assists with management of memory, in some embodiments.

### SIMD Abstraction and Substitution Libraries

SIMD instructions play a crucial role in a variety of RF signal chain operations, significantly enhancing efficiency through parallel processing of data. For example, calculating CRC (Cyclic Redundancy Check) is essential for detecting errors in data transmission, and SIMD instructions accelerate this process by handling multiple data blocks concurrently. Similarly, rotating complex numbers, a common operation in signal modulation and demodulation, benefits from SIMD capabilities.

Additionally, the Fast Fourier Transform (FFT) is used to convert signals between time and frequency domains, a computationally intensive task that becomes more efficient with SIMD instructions. Filtering operations, such as applying digital filters to signals to remove unwanted components or improve signal quality, are also expedited with SIMD. This is particularly true for FIR (Finite Impulse Response) and IIR (Infinite Impulse Response) filters.

Moreover, convolution, a fundamental operation in signal processing for filtering and edge detection, can leverage SIMD to process multiple signal elements simultaneously. Correlation, used in pattern recognition and signal matching, is another operation that gains a significant speed boost from SIMD instructions. Matrix multiplications, which are common in various signal processing algorithms, benefit from the parallel processing capabilities of SIMD, allowing multiple matrix elements to be processed concurrently.

Channel estimation, involving complex mathematical computations to determine the characteristics of the transmission channel, can also be optimized using SIMD. Equalization, the process of compensating for signal distortion caused by the transmission channel, is another intensive task that SIMD accelerates. Lastly, signal detection and decoding, which involves identifying and interpreting received signals, can involve parallelizable tasks that benefit from SIMD.

By utilizing SIMD capabilities, these tasks can be executed simultaneously across multiple data points, thereby enhancing overall performance and ensuring high accuracy in wireless communication systems.

Utilisation of the SIMD capabilities of different types of CPUs from a common source code was therefore an imperative goal at the start of this project and presented a number of unknowns. We evaluated several SIMD substitution and SIMD abstraction techniques and successfully demonstrated that these techniques, when utilised appropriately, can provide the required portability whilst maintaining an optimal level of performance. We applied techniques for translating high level SIMD instructions to lower level SIMD instructions to achieve platform agnostic executability.

Utilization is performed as follows. A version of source code is written that is portable across at least two (a plurality of) instruction set architectures (ISAs), written against an abstraction library that is able to be compiled on each of the plurality of ISAs. When compiled, the abstraction library is linked, statically or dynamically as needed in some cases, avoiding illegal instruction errors because the abstraction library is able to effectively rewrite the instructions executed by the CPU to use the SIMD ISA supported by the underlying CPU. In some embodiments, when a CPU supports multiple SIMD ISAs, the abstraction library may select one to use. In some embodiments, swapping out the abstraction library for another version can fix bugs, improve performance, or enable additional ISAs to be supported, either at runtime or compile time.

In some embodiments we compile for a given CPU at compile time with appropriate libraries for that CPU. In some embodiments, changes are made at compile time using compile flags, or compilation is performed at runtime. In some embodiments, conditional statements or preprocessor directives in the abstraction library cause different code paths to execute when the code is executed on different processors. In some embodiments, binary object code may be compiled with more than one set of binary code in a single executable so that the binary object code can be shared among multiple execution platforms. In some embodiments, a dispatch mechanism can be enabled, for example in the abstraction library, that allows the abstraction library to detect the underlying CPU and emit machine code to be used by that CPU. In some embodiments, identification of a compiler and then sending compiler-specific code to the compiler can be used to generate specific code for a specific processor. In some embodiments, nested namespaces with delegation can be used to provide dynamic dispatch for ISA-specific code. In some embodiments, CPU detection can happen at runtime, such that machine code is also specified at runtime, constituting dynamic dispatch. In some embodiments, ISA-specific code is pre-written for each target ISA and/or CPU to provide optimized performance.

### Containerized Deployment

Processing can be performed using a modern containerized architecture, in some embodiments, using such technologies as Kubernetes, Linux containers, Docker, etc. Since this is being performed in software it is the same as deploying on bare metal hardware. Containerized deployment is described elsewhere herein and in US20250317799A1, hereby incorporated by reference for all purposes.

### In-Memory Signal Processing

Initially, data comes from a lower layer, e.g., a network interface card (NIC) providing digital data in some embodiments, or converted to digital data by lower layer components according to an O-RAN architecture. Each stage of the RF Processing pipeline sends the data to the next stage. We achieve some portion of increased performance by managing, storing, and passing the data in memory without expensive extra reads and writes.

Additionally, in some embodiments we perform signal processing in memory. This is enabled by the use of SIMD instructions. At the point of optimization, data is already in memory. We fix the vector of data, move it to the registers for processing, and once the task is completed, we place it back into memory. This method ensures efficient handling of data and minimizes latency by avoiding unnecessary read and write operations.

Furthermore, each stage of the RF processing pipeline may send data to the next stage using pointers, thereby maintaining a streamlined workflow. Managing the data in memory without extra reads and writes contributes to a significant boost in performance. This approach is particularly beneficial in high-speed wireless communication systems where every millisecond counts.

SIMD instructions enhance the ability to process and analyze RF signals efficiently by leveraging parallel processing capabilities, ensuring optimized performance, and maintaining signal integrity throughout the computation process. The integration of SIMD instructions and in-memory signal processing forms a robust framework that meets the stringent demands of modern wireless communication systems.

In some embodiments, using SIMD instructions with fixed point instead of floating point precision is used for smaller instruction and data size. In some embodiments, using Int-8 and other smaller sizes of integer data types enables a greater amount of packing of instructions and data. In some embodiments.

### Wireless Performance Validation Framework

Validation of the wireless performance is an important aspect in a PHY product development. In this project we wanted to leverage Parallel Wireless'existing wireless performance validation framework based on Matlab. In legacy x86 based flow we would validate the performance of production code by embedding it within Matlab simulations using the MEX (Matlab Executable) framework. For non x86 target platforms, despite this project being a common source code application, it is important to repeat this validation to measure the impact of low-level silicon implementations e.g. in relation to rounding. We faced the problem that Matlab does not run natively on Arm architecture and therefore evolved our validation framework to utilise remote procedure calls through the open source gRPC library [16].

### Platforms Enabled in the Project

This project had the initial ambition to deploy the PHY to at least one x86-based and one Arm-based platform, such as Intel Xeon x86-based vBBU platform and the NXP Layerscape Arm-based Genevisio card. Over the course of the project this objective was exceeded and a further 3 platforms were enabled as shown, covering Ampere and Octeon as well as the following 3 instruction sets: AVX512, Neon, SVE2. The present disclosure is portable to future architectures as well that support the underlying software components.

A test bed was deployed with a commercial 5G core network; commercial SMO and EMS from Parallel Wireless; commercial CU from Parallel Wireless; and a 5G DU, integrating the Parallel Wireless commercial 5G DU-Stack and O-RAN fronthaul software, with the PHY—with both fully Intel x86, and x86+in-line Arm options. The testbed was used to validate operation of the test network in the following scenarios: Establishment of cells on both x86-based and Arm-based DUs; Registration of UEs on all cells; Bi-directional data transfer; Cell reselection between sites, including from Intel x86 to Arm based DUs, or vice-versa. Where Arm was validated, any other CPU architecture could be used, in some embodiments.

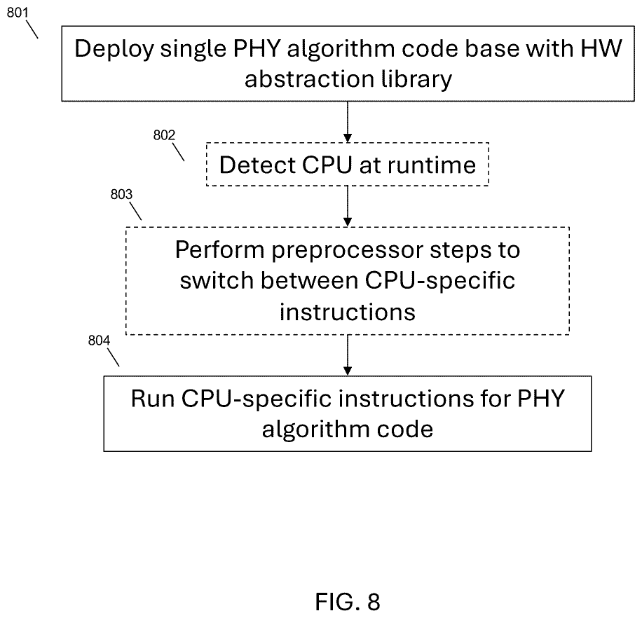

FIG. 8 shows a flowchart in accordance with some embodiments. It is contemplated that a single PHY algorithm code base can be deployed 801, using a HW abstraction library as described; when a CPU is detected at runtime (optionally) 802, a preprocessor performs steps 803 to switch between CPU-specific instructions, and then the instructions can be run 804 to use a specified ISA and GPP CPU with instructions to execute the PHY algorithm using code optimized for the specific chip.

### Additional Embodiments

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods are described in reference to 3GPP, one of skill in the art would understand that these systems and methods could be adapted for use with other wireless standards or versions thereof.

In some embodiments, the software needed for implementing the methods and procedures described herein may be implemented in a high level procedural or an object-oriented language such as C, C++, C #, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 or ARM microprocessor.

In some embodiments, the radio transceivers described herein may be base stations compatible with a Long Term Evolution (LTE) (4G), 6G, 3G, or other radio transmission technology (RAT), radio transmission protocol or air interface, as well as 5G. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, other 3G/2G, 5G, legacy TDD, or other air interfaces used for mobile telephony. 5G core networks that are standalone or non-standalone have been considered by the inventors as supported by the present disclosure. Additionally, the inventors have understood and appreciated that there are a variety of functional splits being used today by network operators and equipment vendors, and although the focus of this document is on 5G DU PHY processing, other RATs and processing at other points in the radio chain, e.g., CU or RU, O-DU, O-RU, O-CU, etc., could also be enhanced using the disclosed methods and systems and could be beneficially deployed.

Although the above systems and methods are described in reference to the 5G standard, one of skill in the art would understand that these systems and methods could be adapted for use with other wireless standards or versions thereof. The inventors have understood and appreciated that the present disclosure could be used in conjunction with various network architectures and technologies. Wherever a 5G technology is described, the inventors have understood that other RATs have similar equivalents, such as a eNodeB for 4G equivalent of gNB, and the other aspects of the present disclosure could be made to apply, in a way that would be understood by one having skill in the art. Processing for one or both of FDD PHY and TDD PHY according to the present disclosure is contemplated. Processing for a plurality of radio access technologies is contemplated, e.g., the present methods and systems could be used to provide processing for both 4G and 5G PHY, for example by deploying multiple systems each with the ability to provide PHY processing for one RAT.

In some embodiments, the software needed for implementing the methods and procedures described herein may be implemented in a high level procedural or an object-oriented language such as C, C++, C #, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions with any instruction set. Cross-compilation from one platform or instruction set to another instruction set is contemplated. The use of multiple underlying processor architectures within a single operator network or within a single radio deployment (e.g., tower) is contemplated. The use of hypervisors, containers, or other virtualization technology, on one or more instruction set architectures, at the deployment site, is contemplated.

The ability of being able to “mix and match” between different processor architectures is contemplated. Different cells could be deployed on different platforms, for example, or DU and CU and SMO could be deployed on different platforms. Individual PHY processing chains may be kept on the same server, in some embodiments; this allows for the in-memory optimizations described elsewhere herein to be effective. However, for deployments where multiple PHY processing chains are contemplated, they may be split apart across multiple platforms, hardware servers, etc., in some embodiments.

The foregoing discussion discloses and describes merely exemplary embodiments of the present disclosure. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present disclosure may be embodied in other specific forms without departing from the spirit or essential characteristics thereof. For example, wireless network topology can also apply to wired networks, optical networks, and the like. Various components in the devices described herein may be added, removed, split across different devices, combined onto a single device, or substituted with those having the same or similar functionality.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment.

1. A method for deploying a platform-agnostic 5G distributed unit (DU) physical layer (PHY) computation application on general-purpose processors, comprising:
for a single PHY processing chain, deploying 5G DU PHY application that is decoupled from the implementation specifics of the target platform; and
deploying scheduler, DPDK, and SIMD abstraction and substitution libraries to achieve platform-agnostic functionality.

2. The method of claim 1, wherein the 5G DU PHY application is deployable on both x86-based and Arm-based general-purpose processors.

3. The method of claim 1, further comprising RF signal processing that provides functional equivalence, algorithmic near-equivalence, code reuse, compute performance, flexibility, IP portability, and future proofing across multiple architectures.

4. The method of claim 1, wherein the SIMD abstraction and substitution libraries translate high level SIMD instructions to lower level SIMD instructions specific to the target platform at compile time.

5. The method of claim 1, further comprising performing in-memory signal processing wherein data is managed, stored, and passed between stages of an RF processing pipeline using pointers.

6. The method of claim 5, wherein signal processing operations are performed by moving data to registers for processing and placing the data back into memory upon completion.

7. The method of claim 1, wherein the scheduler comprises a Linux scheduler configured for real-time applications with pre-emptive task execution.

8. The method of claim 1, further comprising deploying the 5G DU PHY application in a containerized architecture.

9. The method of claim 1, wherein the 5G DU PHY application supports instruction sets including AVX512, Neon, and SVE2.

10. The method of claim 1, wherein the 5G DU PHY application interfaces with a layer 2 through a 5G Function Application Platform Interface (FAPI).

11. The method of claim 1, wherein the DPDK provides an environment abstraction layer for interfacing with underlying hardware, memory management, and poll mode drivers for network interfaces.

12. The method of claim 1, wherein the 5G DU PHY application performs signal processing operations including one or more of CRC calculation, complex number rotation, Fast Fourier Transform, filtering, convolution, correlation, matrix multiplication, channel estimation, equalization, and signal detection and decoding.

13. The method of claim 1, wherein the 5G DU PHY application is deployable on processors ranging from embedded systems on chip to server-class processors to cloud platforms.

14. The method of claim 1, further comprising deploying a centralized unit (CU) on a different processor architecture than the DU PHY application.

15. The method of claim 1, wherein the 5G DU PHY application uses fixed point precision instead of floating point precision for SIMD operations.

16. The method of claim 1, wherein the 5G DU PHY application is compiled from a single source codebase for multiple target processor architectures.

17. The method of claim 1, further comprising interfacing with a radio unit (RU) according to an O-RAN split option 7-2 configuration.

18. A system for platform-agnostic 5G distributed unit physical layer processing, comprising:
a general-purpose processor;
a 5G DU PHY application executing on the general-purpose processor, wherein the 5G DU PHY application is decoupled from implementation specifics of the general-purpose processor; and
SIMD abstraction libraries configured to translate SIMD instructions to platform-specific instructions for the general-purpose processor.

19. The system of claim 18, wherein the general-purpose processor comprises an x86-based processor or an Arm-based processor.

20. The system of claim 18, further comprising DPDK libraries providing hardware abstraction for memory management and network interface access.
